(19) United States
(12) Patent Application Publication
(10) Pub. No.: US 2004/0212467 A1
(43) Pub. Date: Oct. 28, 2004

(54) Relay

(75) Inventors: Dieter Schwenkedel, Frickenhausen (DE); Frank Hoenig, Deizisau (DE)

Correspondence Address: LAW OFFICE OF BARRY R LIPSITZ, 755 MAIN STREET, MONROE, CT, 06468, US

(73) Assignee: Alcoa Fujikura Gesellschaft mit beschraenkter Haftung, Frankfurt/Main (DE)

(21) Appl. No.: 10/267,032

(22) Filed: Oct. 7, 2002

(30) Foreign Application Priority Data
Oct. 8, 2001 (DE) 101 50 393

(51) Int. Cl. H01H 67/02

(52) U.S. Cl. 335/128

(57) ABSTRACT

To provide a relay, in particular for 42-volt automotive electrical systems, comprising a housing (10), two contact elements (60, 62) passing through the housing (10) and projecting beyond it, a magnetic coil (16) disposed in the housing and an armature (22) which is mounted pivotably in the housing (10), can be moved by means of the magnetic coil (16) and by means of which a contact bridge (100) can be moved between a contact position, electrically connecting the contact elements (60, 62), and an interruption position, which relay operates reliably at voltages higher than 12 volts, it is proposed that an elastic spring element (110) is movable between two elastic spring states by means of the armature (22) and that the elastic spring element (110) in one elastic spring state keeps the contact bridge (100) in the contact position and in the other elastic spring state keeps it in the interruption position.

The invention relates to a relay, in particular a relay which switches voltages higher than 12 volts, preferably a relay for 42-volt automotive electrical systems, comprising a housing, two contact elements passing through the housing and projecting beyond it, a magnetic coil disposed in the housing and an armature which is mounted pivotably in the housing, can be moved by means of the magnetic coil and by means of which a contact bridge can be moved between a contact position, electrically connecting the contact elements, and an interruption position.

Relays of this type are known from the prior art, the relays of the conventional type of construction always having the problem of forming an arc at voltages of over 12 volts, in particular in 42-volt electrical systems.

In particular, the known relays are also problematical when they are used as power circuit breakers, that is to say serve for switching currents of over 50 amperes.

The invention is therefore based on the object of providing a relay which operates reliably at voltages higher than 12 volts.

This object is achieved according to the invention in the case of a relay of the type described at the beginning by an elastic spring element being movable between two elastic spring states by means of the armature and by the elastic spring element in one elastic spring state keeping the contact bridge in the contact position and in the other elastic spring state keeping it in the interruption position.

The advantage of the solution according to the invention can be seen in the fact that the elastic spring element creates the possibility of moving the contact bridge quickly over great contact clearances and consequently of largely suppressing the formation of an arc, in particular during the transition from the contact position into the interruption position.

It is particularly advantageous in this respect if the elastic spring element is formed in such a way that, when there is a change from one elastic spring state to the other, it moves the contact bridge with greater angular acceleration than the armature in this case moves, so that the elastic spring element serves the purpose of transferring the contact bridge with greater angular acceleration from the contact position into the interruption position, or vice versa, in spite of “slower” movement of the armature.

With regard to the elastic spring states, a wide variety of possibilities are conceivable.

One possibility is that of using spring-actuated lever mechanisms as the elastic spring elements, for example spring-actuated toggle lever mechanisms which have, for example, two stable buckling states.

It is particularly advantageous if the elastic spring states are formed by form states of the elastic spring element, into which the latter is respectively transferred by the armature.

The elastic spring states may in this case be such that one elastic spring state is a stable form state, while the other elastic spring state is an unstable form state.

It is particularly advantageous, however, if the elastic spring states are in the same way stable form states of the elastic spring element which are separated from each other by means of an unstable intermediate state.

Consequently, the armature only has to be formed in such a way that it can apply the required force when changing over from one elastic spring state to the other elastic spring state, but not in such a way that it has to apply a particularly high force in one of the elastic spring states to maintain it.

The form states may in this case be in principle multidimensional bending states, that is to say bending states of plate-like spring elements.

A particularly simple solution provides, however, that the form states are one-dimensional bending states of the elastic spring element.

The one-dimensional bending states can preferably be achieved by the elastic spring element being clamped between counter bearings, and by the clamping allowing two different bending states to be formed as form states.

A particularly simple solution in this respect provides that the elastic spring element is formed as a leaf spring element and the bending states are formed by bending states of the leaf spring element.

A preferred type of construction of the relay provides that, in the starting position of the armature, the elastic spring element keeps the contact bridge in the interruption position and that, in the attracted position of the armature, the elastic spring element keeps the contact bridge in the contact position.

The bending states are in this case preferably chosen such that the elastic spring element in a first bending state is bent away from the contact elements and in a second bending state is bent toward the contact elements.

With regard to the mounting of the elastic spring element in the housing, a wide variety of possibilities are conceivable.

For example, it would be conceivable to mount the elastic spring element in the housing independently of the armature, for example to mount it by clamping it between abutments, and just allow the armature to act on the elastic spring element to move it back and forth between the elastic spring states.

However, a constructionally particularly simple solution provides that the elastic spring element is mounted in the housing by means of the armature.

In the simplest case, the elastic spring element is securely connected to the armature and is also mounted by it in the housing.

To allow the elastic spring element to be tensioned for forming the two form states, it is preferably provided that the elastic spring element has at least one spring leg which is clamped between two abutments and is consequently supported.

A particularly simple solution provides in this respect that the elastic spring element is supported on the one hand by means of the armature as an abutment and on the other hand by means of an abutment which is fixed to the housing.

This possibility allows the elastic spring element to be mounted in the housing by means of the armature and additionally supported on an abutment fixed to the housing, in order to give the elastic spring element the desired elastic spring states.

It is preferably provided in this respect that the abutment lies on a side remote from the contact bridge.

A particularly advantageous constructional solution provides that the elastic spring element has two spring legs which are spaced apart, extend from a contact bridge holder to an abutment and are consequently clamped between the contact bridge holder and the abutment.

An actuating leg which is connected to the contact bridge holder and can be actuated by the armature is in this case preferably provided between the spring legs.

In the case in which the elastic spring element is mounted by means of the armature, it is provided in this respect that the actuating leg is fixed to the armature and consequently the actuating leg not only actuates the elastic spring element but also fixes the contact bridge holder by means of the pivotable mounting of the armature, so that ultimately the armature acts via the actuating leg as an abutment for the contact bridge holder.

To prevent the movement of the contact bridge holder being rigidly coupled to the movement of the armature via the actuating leg, it is preferably provided that the actuating leg forms a flexible connection between the armature and the contact bridge holder and consequently allows the elastic spring element to move the contact bridge with greater angular acceleration than the armature moves.

For example, it would be conceivable to guide or mount the contact bridge separately from the elastic spring element.

However, a constructional solution in which the elastic spring element carries the contact bridge is particularly simple.

In this case, the elastic spring element preferably carries the contact bridge with the contact bridge holder.

To give the contact bridge the possibility of engaging against the contact elements with the same force as far as possible in the switching position, it is preferably provided that the elastic spring element is provided with a twistable element, holding the contact bridge, so that there is no need for the elastic spring element holding the contact bridge to be positioned so exactly that the contact bridge rests with substantially the same force on the contact elements in the switching position, since this can be balanced out by the twistable element.

It is preferably provided in this respect that the twistable element is a spring web.

A constructionally particularly simple solution provides in this respect that the twistable element is formed onto the elastic spring element as a unitary element.

A constructionally particularly simple and therefore low-cost solution provides furthermore that a contact bridge carrier is formed onto the twistable element as a unitary element, which then holds the counter contacts and preferably at the same time establishes an electrically conducting connection between the counter contacts.

With regard to the connection of the connection elements to external lines, no details have been given with the explanation so far of individual exemplary embodiments.

A particularly advantageous exemplary embodiment therefore provides that the contact elements have connection elements protruding beyond the housing, and that a connection element respectively forms with one of the counter connection elements an electrical connection which can rotate about a longitudinal axis of the same.

The advantage of this solution can be seen in the fact that the rotatable connection between the counter connection element and the corresponding connection element has created the possibility of compensating for torsional forces applied by lines via the counter connection element, since the counter connection element can rotate correspondingly in relation to the connection element.

By contrast with this, in the case of the previously known relays, in particular when a power circuit breaker is in question, the contact elements are always connected to the supply lines by means of a screwed connection, so that the contact elements had to be formed in such a way that they withstood torsional elements applied via supply lines.

The connection elements may in principle be formed in any way desired.

A particularly simple variant of the connection elements provides that they are contact pins which are circular-cylindrical with respect to the longitudinal axis.

Contact pins of this type are particularly simple elements which can on the one hand be produced in a simple manner and on the other hand allow a simple connection with the connection elements, in particular if the connection is to be rotatable.

No details have been provided so far with regard to the formation of the counter connection elements. An advantageous solution therefore provides that the counter connection elements have ferrule terminals.

In principle, these ferrule terminals would be directly connectable to the contact pins.

In the case of relays formed as power circuit breakers, however, there is the need to produce a contact resistance that is as low as possible.

For this reason, it is preferably provided that the ferrule terminals are provided with contact inserts.

These contact inserts may be formed in a wide variety of ways.

For example, it would be conceivable to provide the contact inserts with individual projections which produce a favorable contact with the contact pins.

A particularly advantageous exemplary embodiment provides that the contact inserts are formed as contact cages which enclose the contact pins and consequently provide electrical contact between the latter and the ferrule terminals that is favorable for high currents.

A particularly advantageous form of the contact cages provides that they have contact laminations, so that a good electrical contact can be achieved by means of the contact laminations, which are preferably formed in a resilient and bent manner.

The electrical contact suitable for high currents can be realized in a particularly advantageous way if the contact laminations run in the axial direction and in the azimuthal direction around a center axis of the contact cage. Following such a path allows the contact laminations to achieve particularly advantageous close contact with the contact pins.

In this case, the contact laminations preferably run helically or spirally around the center axis of the contact cage, at least in some portions.

To establish a quick connection between the contact pins and the counter connection elements, it is preferably provided that the counter connection elements are disposed in a connection housing. A connection housing of this type is, for example, a housing made of an insulating material, preferably plastic.

To ensure in this case that the counter connection elements can, rotate, it is provided that the counter connection elements are rotatably disposed in the connection housing, a number of counter connection elements being rotatably disposed independently of one another in the connection housing.

No details have been given so far with regard to the form of the contact elements within the housing.

In the case of the previously known solutions, the contact elements are often formed as an angle from flat material.

According to the invention, however, a constructionally particularly simple solution provides that the contact elements form free-standing contact bodies, which preferably rise up above a carrier body of the housing and, for example, are formed in a column-like manner.

The contact bodies are in this case suitably provided on their end faces, preferably on the side opposite from the carrier body, with contact parts, which for their part then interact with the contact bridge, in order to establish an electrically conducting contact between the contact elements by means of the contact bridge.

Irrespective of the type of contact elements, contact parts riveted onto the contact elements have always been used so far in the case of power circuit breakers.

However, according to the invention it has proven to be constructionally particularly advantageous if the contact elements are provided with plated-on contact parts.

Plated-on contact parts of this type represent a considerable advantage in terms of production and cost.

The contact parts are in this case preferably produced from silver or palladium-silver and applied to the contact elements by plating processes.

Further features and advantages of the invention are the subject of the following description and the graphic representation of an exemplary embodiment.

In the drawing:

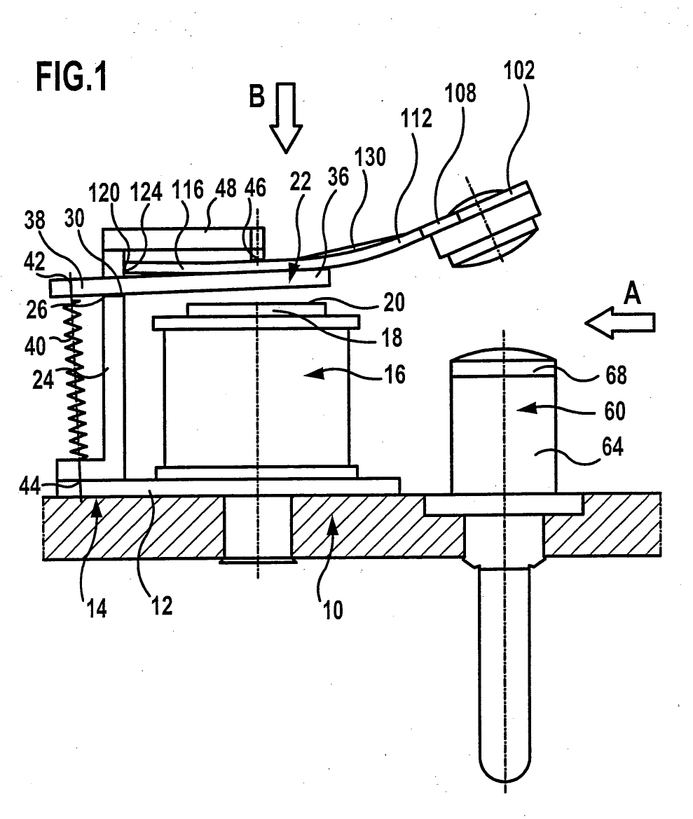

FIG. 1 shows a first exemplary embodiment, represented partly in section, of a relay according to the invention with the contact bridge in the interruption position;

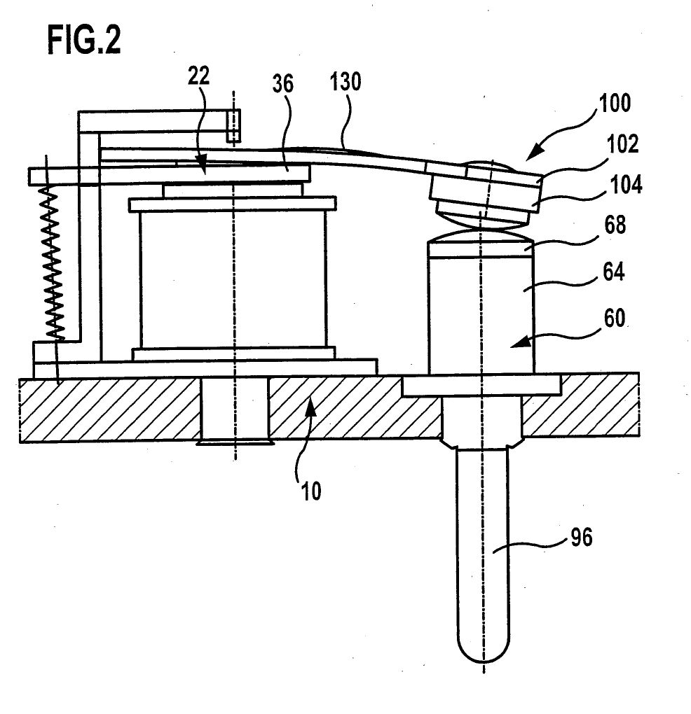

FIG. 2 shows a representation of the first exemplary embodiment, similar to FIG. 1, with the contact bridge in the contact position;

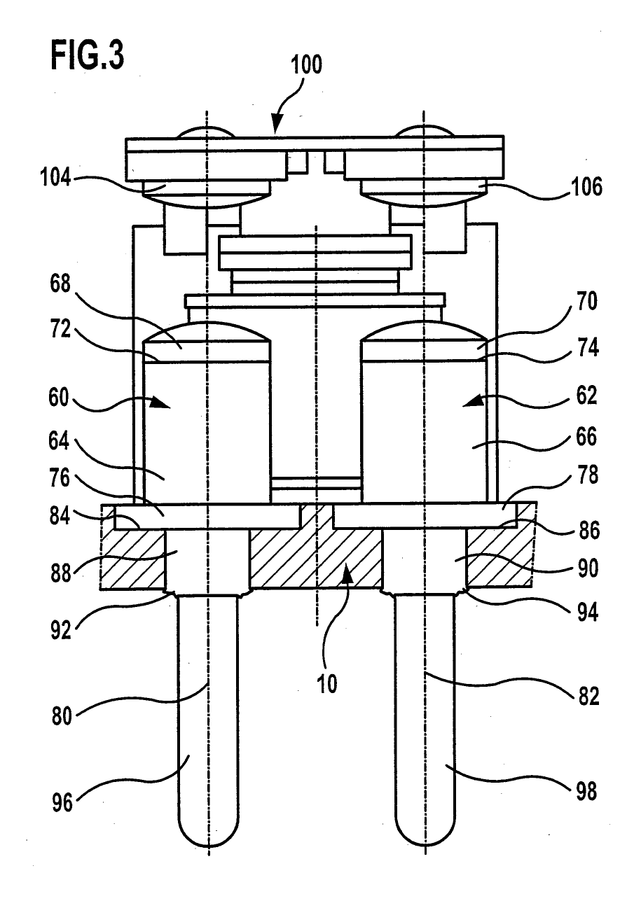

FIG. 3 shows a view in the direction of the arrow A in FIG. 1;

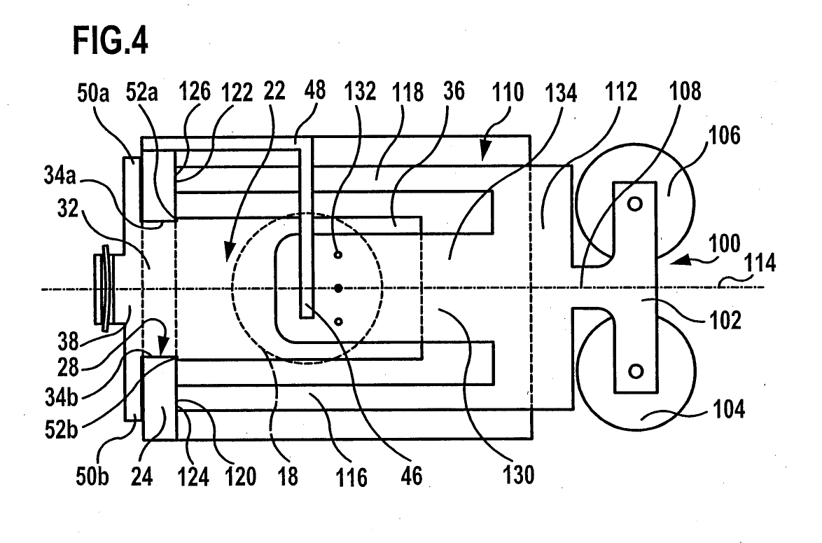

FIG. 4 shows a plan view in the direction of the arrow B in FIG. 1;

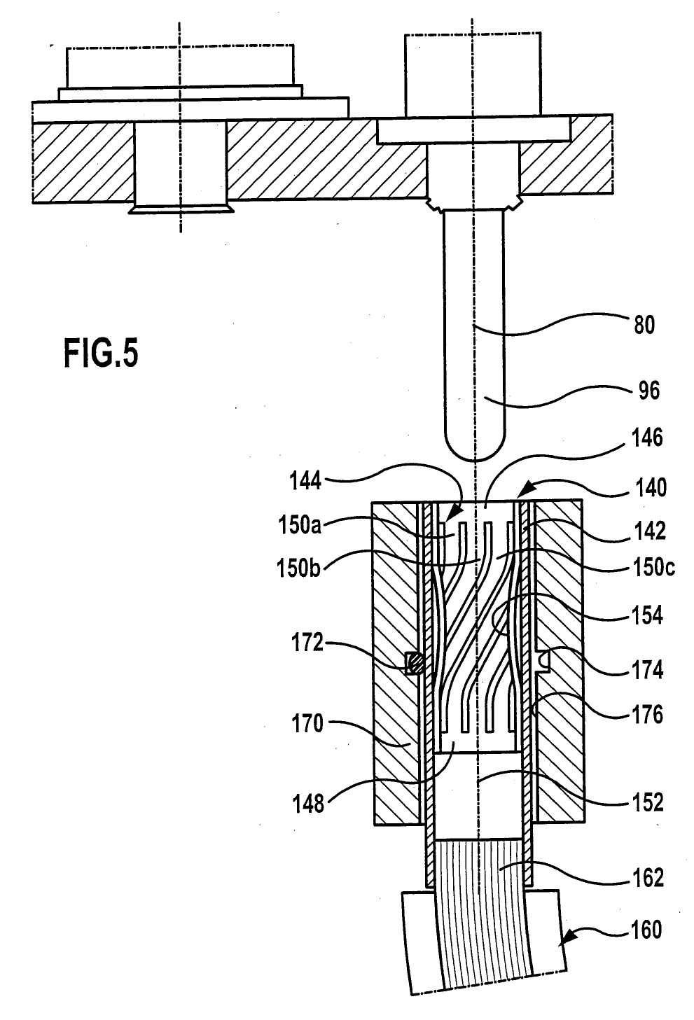

FIG. 5 shows a representation of a connection between a contact element and an external connection with a counter connection element according to the invention in the case of the first exemplary embodiment;

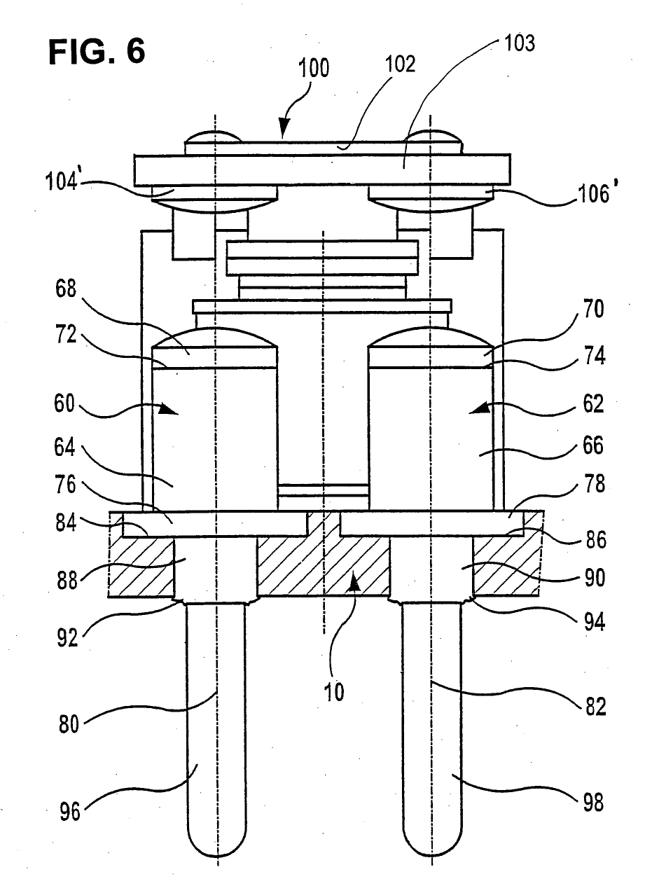

FIG. 6 shows a representation similar to FIG. 3 of a second exemplary embodiment of a relay according to the invention;

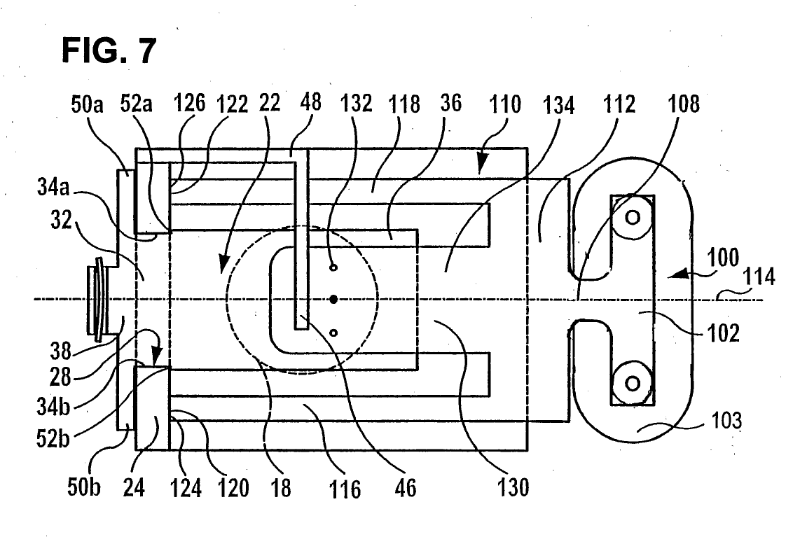

FIG. 7 shows a representation similar to FIG. 4 of the second exemplary embodiment of the relay according to the invention and

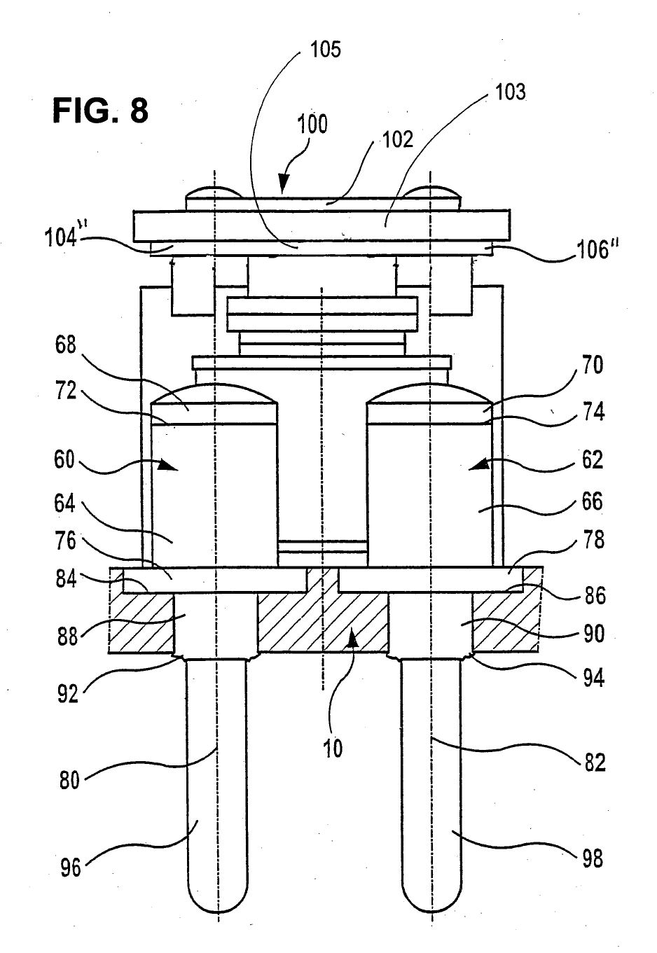

FIG. 8 shows a representation similar to FIG. 3 of a third exemplary embodiment of a relay according to the invention.

A first exemplary embodiment of a relay according to the invention, represented in FIGS. 1 to 4, comprises a carrier body which represents part of a housing, is designated as a whole by 10 and on which there rests a lower leg 12 of a yoke, designated as a whole by 14.

On a side of the lower leg 12 opposite from the carrier body 10 there is seated a magnetic coil, which is designated by 16 and encloses a magnetizable core 18, which is connected to the lower leg 12 of the yoke 14.

The magnetizable core 18 has an end face 20 which is remote from the lower leg 12 and opposite which an armature 22 is disposed, the armature 22 being mounted pivotably about an axis 26 on a cross-leg 24 of the yoke 14 running transversely with respect to the lower leg 12 of the yoke 14.

As represented in FIG. 4, the pivotable mounting of the armature 22 takes place through a cutout 28 in the cross-leg 24 of the yoke 14, the cutout 28 forming a supporting surface 30 which faces the carrier body 10 and on which the armature 22 rests with a bearing web 32, the bearing web 32 being guided in the direction of the axis 26 between side walls 34a and 34b of the cutout 28.

The armature 22 consequently comprises an armature plate 36, which lies opposite the end face 20 of the magnetizable core 18 and is connected to the longitudinal web 32, and, on a side of the bearing web 32 opposite from the armature plate 36, a continuation 38, on which a tension spring 40 acts with one end 42, while an opposite end 44 of the tension spring 40 is mounted either on the carrier body 10 or on the lower leg 12 of the yoke 14.

When the coil 16 is not energized, the armature 22 is in a starting position, in which the tension spring 40 has the tendency to move the armature 22 as far away as possible from the end face 20 of the magnetizable core 18. This starting position is fixed by a stop lug 46, which is held on a stop arm 48 connected to the cross-leg 24 of the yoke 14.

The stop lug 46 is in this case preferably seated above the armature plate 36 of the armature 22.

For undisplaceable mounting of the armature 22 transversely with respect to the axis 26, on the one hand the continuation 38 is made wider than the cutout 28, so that the continuation 38 engages with lugs 50a and 50b protruding laterally beyond the cutout 28 against the cross-leg 24 of the yoke 14. What is more, the armature plate 36 is also made wider than the cutout 28, and consequently engages with projections 52a, b laterally of the bearing web 32, and consequently also laterally of the cutout 28, against the cross-leg 24 of the yoke 14 on sides opposite from the lugs 50a and 50b.

Preferably provided on the carrier plate 10, on a side of the magnetic coil 16 opposite from the cross-leg 24, are two contact elements 60 and 62, which have contact carrier bodies 64 and 66 which rise up in a column- or pin-like manner above the carrier body 10 and onto the end faces of which contact parts 68 and 70 are plated. The contact parts 68 and 70 are in this case preferably made of silver or palladium-silver in the form of a layer applied to an end face 72 and 74, respectively, remote from the carrier body 10 of the contact carrier bodies 64 and 66.

For securely anchoring the contact elements 60 and 62, they are provided with supporting flanges 76 and 78, which preferably extend beyond the contact carrier bodies 64 and 66 in the radial direction with respect to a longitudinal axis 80 and 82 of the respective contact element 60 and 62 and rest on a corresponding supporting surface of the carrier body 10.

Furthermore, the contact elements 60 and 62 pass with projections 88 and 90 through the carrier body 10, the projections 88 and 90 being anchored on the carrier body 10 by additional positively engaging elements 92 and 94, preferably by caulked claws.

Preferably connected to the projections 88 and 90 there are then contact pins 96 and 98, which are preferably disposed coaxially with respect to the longitudinal axes 80 and 82.

The contact elements 60 and 62 according to the invention are preferably formed as turned parts, so that the contact pins 96 and 98 and the contact carrier bodies 64 and 96 as well as the supporting flanges 76 and 78 and the projections 88 and 90 are disposed coaxially in relation to one another.

To be able to establish an electrical connection between the contact elements 60 and 62, in particular the contact parts 68 and 70 of the same, a contact bridge designated as a whole by 100 is provided, which has a contact bridge carrier 102 and counter contacts 104 and 106 which are held on the latter and can be made to engage against the contact parts 68 and 70 in a switching position of the relay, represented in FIG. 2, and are at a sufficiently great distance from them in an interruption position.

The contact bridge carrier 102 is then for its part connected to an elastic spring element 110, which, with a front portion 112 facing the contact bridge 100, forms a contact bridge holder against which the web 108 butts, the web 108 and the contact bridge carrier 102 preferably being formed onto the elastic spring element 110 as a unitary element and these elements being formed, for example punched out, from a piece of leaf spring.

The web 108 in this case preferably forms a torsion spring element, which has a tilting axis 114 which runs transversely with respect to the axis 26 and also transversely with respect to the contact bridge carrier 102, lies between the counter contacts 104 and 106 and tilts the contact bridge carrier 102, so that, in the contact position, the two counter contacts 104 and 106 are made to engage against the corresponding contact parts 68 and 70 even if the contact bridge holder 112 is not aligned exactly parallel to the contact parts 68 and 70, the web 108 then undergoing slight torsion.

The elastic spring element 110 also has two spring legs 116 and 118, which extend from the contact bridge holder 112 in the direction of the cross-leg 124 and are supported with their ends 120 and 122 that are remote from the contact bridge holder 112 on the cross-leg 28 to the sides of the cutout 28, for example in receptacles 124 and 126.

Furthermore, an actuating leg 130 also leads from the contact bridge holder 112 in the direction of the armature 22 and preferably rests on the side of the armature plate 36 remote from the end face 20 of the magnetizable core and is, for example, securely connected to the armature plate 36 in the region of a connecting point 132 either by a riveted connection or welded connection or a similar connection, the actuating leg 130 of the elastic spring element 110 also forming between the connecting point 132 and the contact bridge holder 112 a flexible portion 134 which allows the contact bridge holder 112 to be in a position deviating from the position of the armature plate 36.

The fixing of the armature plate 36 transversely with respect to the axis 26 in relation to the cross-leg 24 makes it possible, by means of the pivotable mounting of the armature 22 and the actuating leg 130 securely connected to the armature plate 36, to keep the contact bridge holder 112 at a distance from the receptacles 124 and 126 which is less than the length of the spring legs 116 and 118. This has the effect that the spring legs 116 and 118 have the tendency to bend in the longitudinal direction, resulting in two stable form states, that is the position bent away from the contact parts 68 and 70, represented in FIG. 1, or the position bent toward the contact parts 68 and 80, represented in FIG. 2.

These different form states can be brought about by moving the armature plate 36 about the axis 26.

If the armature plate 36 is in its starting position, that is to say made to engage against the stop lug 46 by the tension spring 40, the armature plate 36 engaging against the stop lug 46 with the actuating leg 130 resting on it, the spring legs 116 and 118 are in their position bent away from the contact parts 68, and consequently the entire elastic spring element 110 is likewise in the first form state, bent away from the contact parts 68 and 70.

If, however, by energizing the coil 16, the armature plate 36 is drawn into the attracted position against the end face 20 of the magnetizable core 18, the spring legs 116 and 118 go over from their position in which they are initially bent away from the contact parts 68 into an unstable state and then into the position bent in the direction of the contact parts 68, represented in FIG. 2, so that the entire elastic spring element 110 is then also in its second form state, in which it is bent in the direction of the contact parts 68.

In the second form state of the elastic spring element, the latter consequently keeps the contact bridge 100 in the contact position and, in particular, thereby makes the counter contacts 104 and 106 engage with the necessary contact pressure against the contact parts 68 and 70, while in the first form state the contact bridge 100 is in its interruption position, represented in FIG. 1.

The two form states of the elastic spring element 110 then have the effect that, on passing through the unstable intermediate position, the first form state suddenly changes into the second form state, or the second form state suddenly changes into the first form state, to be precise by corresponding biasing of the spring legs 116 and 118, more quickly than the armature plate 36 moves.

In this case, the flexible portion 134 of the actuating leg 130 of the elastic spring element 110 serves the purpose of making the contact bridge holder 110 able to move in relation to the armature plate 36, in order to perform movements over a greater angular distance than corresponds to the angular distance of the armature plate 36 between the starting position and the position in which it is attracted to engage against the end face 20.

This creates the possibility of carrying out the transition of the contact bridge 100 from the interruption position into the contact position or —more importantly—from the contact position into the interruption position as quickly as possible and, in particular, of achieving a greatest possible contact clearance between the counter contacts 104 and 106 and the contact parts 68 and 70 as quickly as possible in the interruption position, which is required in particular when switching high power outputs at 42 volts, to achieve quickest possible breaking of the arc which forms when the contact is opened.

Furthermore, the two form states of the elastic spring element 110 also advantageously make it possible to achieve a contact clearance in the interruption position of the contact bridge 100 from the contact parts 68 and 70 which corresponds to a greater angular distance than the angular distance of the armature plate 36 from the end face 20 in the starting position, so that considerable advantages over conventional relay constructions can be achieved, in particular for voltages in the 42-volt range, by the two form states of the elastic spring element 110.

In the case of relays used as power circuit breakers, the contact elements 60 and 62 are usually connected to the supply lines by a screwed connection.

By contrast with this, in the case of the relay according to the invention the contact elements 60 and 62 are provided with contact pins 96 and 98.

For receiving these contact pins, a counter connection element 140 is provided for each of the contact pins 96, 98, comprising a ferrule terminal 142 and a contact cage 144 which is inserted into the ferrule terminal 142 and establishes between the ferrule terminal 146 and the corresponding contact pin 96 or 98 a connection which can be subjected to high current loading.

The contact cage 144 is in this case formed in such a way that it comprises an upper lamination carrier 146 and a lower lamination carrier 148, between which there extend contact laminations 150 which are spaced apart but do not run parallel to a center axis 152 of the ferrule terminal 142, and consequently also of the counter connection element 150, but in an azimuthal direction around the center axis 152, for example helically, and in this way can also engage against an outer side of the contact pins 96 or 98.

In addition, the contact cage 144 is formed in such a way that, between the lamination carriers 146 and 148, the laminations 150 are bent in the direction of the center axis 152, and consequently have between the lamination carriers 146 and 148 a kind of bottleneck shape or hourglass shape with a radial constriction 154. The multiplicity of spaced-apart contact laminations 150 of the contact cage 144, their bending in the direction of the center axis 152, which forms a constriction 154, and their path in the azimuthal direction, that is to say their helical path for example, have the effect that a connection between the ferrule terminal 142 and the respective contact pin 96 and 98 which can be subjected to high current loading is possible, but also has the further advantage that the ferrule terminal 142 is rotatable about the longitudinal axis 80 or 82 of the respective contact pin 96 or 98 in spite of the electrical connection to the respective contact pin 96 and 98 that can be subjected to current loading.

Therefore, if the ferrule terminal 142 is connected to a cable 160, for example by a crimped connection or a soldered connection to the electrical conductors 162 of the cable 160, the connection between the ferrule terminal 142 and the respective contact pin 96 or 98 can balance out torsional loads originating from the cable 160, that is by the ferrule terminal 142 rotating about the respective longitudinal axis 80 or 82 of the corresponding contact pin 96 or 98. This creates the possibility of keeping the contact elements 60 or 62 largely free of torsional forces which are introduced via the cables 160, which once again creates the possibility of anchoring the contact elements 60 and 62 in a constructionally more simple way in the carrier body 10, since they have to withstand far lower torsional loads than the contact elements of the previously known power-switching relays.

The ferrule terminal 142 may in this case run from a portion 164, which receives the contact cage 144, in a straight or angled away manner to the portion 166, which is connected to the respective electrical conductors 162.

If the counter connection elements 140 for the contact pins 96 or 98 are, for example, disposed in a common housing 170, both counter connection elements 140 are preferably rotatably held independently of each other in the housing 170.

This takes place in the simplest case by the ferrule terminal 142 being provided with a projection 172, which engages in a groove 174 of the housing 170, while the entire ferrule terminal 142 is rotatably held in a cylindrical aperture 176 of the housing. Consequently, even when the housing 170 is stationary, the respective ferrule terminal 142 can rotate in the latter about the corresponding longitudinal axis 80 or 82 of the corresponding contact pin 96 or 98 and consequently balance out torsional loads coming from the cable 160.

There is preferably also the possibility, for securing the electrical connection between the counter connection element 140 and the corresponding contact pin 96 or 98, of fixing the housing 170 in relation to the carrier body 10 as part of a housing of the relay, not represented in its entirety, for example by a snap-fitting or latching connection or some other connection, and of thereby preventing the respective counter connection element 140 from sliding off the corresponding contact pin 96 and 98, without at the same time hindering the torsional balance between the counter connection element 140 and the corresponding contact pin 96 or 98.

In the case of a second exemplary embodiment of a relay according to the invention, represented in FIGS. 6 and 7, the counter contacts 104′ and 106′ are not held directly on the contact bridge carrier 102, but on a carrier plate 103, which is connected to the contact bridge carrier 102.

The carrier plate 103 in this case extends over the counter contacts 104′ and 106′ and establishes an electrical connection between them.

In this case, the counter contacts 104′ and 106′ are preferably applied to the carrier plate 103 by plating.

In the case of a fourth exemplary embodiment, represented in FIG. 8, the counter contacts 104″ and 106″ are formed by a common plating 105, which is applied to the carrier plate 103 and extends over the entire carrier plate 103, so that both the counter contact 104″ and the counter contact 106″ can be formed by the continuous plating.

1. A relay, in particular for 42-volt automotive electrical systems, comprising a housing (10), two contact elements (60, 62) passing through the housing (10) and projecting beyond it, a magnetic coil (16) disposed in the housing and an armature (22) which is mounted pivotably in the housing (10), can be moved by means of the magnetic coil (16) and by means of which a contact bridge (100) can be moved between a contact position, electrically connecting the contact elements (60, 62), and an interruption position, characterized in that an elastic spring element (110) is movable between two elastic spring states by means of the armature (22) and in that the elastic spring element (110) in one elastic spring state keeps the contact bridge (100) in the contact position and in the other elastic spring state keeps it in the interruption position.

2. The relay according to claim 1 characterized in that, when there is a change from one elastic spring state to the other, the elastic spring element (110) moves the contact bridge (100) with greater angular acceleration than the armature in this case moves.

3. The relay according to claim 1 or 2, characterized in that the elastic spring states are formed by form states of the elastic spring element (110).

4. The relay according to one of the preceding claims, characterized in that the elastic spring states are in the same way stable form states of the elastic spring element (110) which are separated from each other by means of an unstable intermediate state.

5. The relay according to claim 3 or 4, characterized in that the form states are one-dimensional bending states of the elastic spring element (110).

6. The relay according to one of the preceding claims, characterized in that the elastic spring element (110) is formed as a leaf spring element and the bending states are formed by bending states of the leaf spring element (110).

7. The relay according to one of the preceding claims, characterized in that, in the starting position of the armature (22), the elastic spring element (110) keeps the contact bridge (100) in the interruption position and, in the attracted position of the armature (22), the elastic spring element (110) keeps the contact bridge (100) in the contact position.

8. The relay according to one of preceding claims, characterized in that the elastic spring element (110) in a first bending state is bent away from the contact elements (60, 62).

9. The relay according to claim 8, characterized in that the elastic spring element (110) in a second bending state is bent toward the contact elements (60, 62).

10. The relay according to one of the preceding claims, characterized in that the elastic spring element (110) is mounted in the housing (10) by means of the armature (22).

11. The relay according to one of the preceding claims, characterized in that the elastic sring element (110) has at least one spring leg (116, 118), which is clamped between two abutments (112, 124, 126).

12. The relay according to claim 11, characterized in that the elastic spring element (110) is supported on the one hand by means of the armature (22) as an abutment and on the other hand by means of an abutment (124, 126) which is fixed to the housing.

13. The relay according to claim 12, characterized in that the abutment (124, 126) which is fixed to the housing lies on a side remote from the contact bridge (100).

14. The relay according to one of the preceding claims, characterized in that the elastic spring element (110) has two spring legs (116, 118) which are spaced apart and extend from a contact bridge holder (112) to an abutment (124, 126).

15. The relay according to claim 14, characterized in that an actuating leg (130) which is connected to the contact bridge holder (112), can be actuated by the armature (22) is disposed between the spring legs (116, 118).

16. The relay according to claim 15, characterized in that the actuating leg (130) is fixed to the armature (22).

17. The relay according to claim 15 or 16, characterized in that the actuating leg (130) forms a flexible connection between the armature (22) and the contact bridge holder (112).

18. The relay according to one of the preceding claims, characterized in that the elastic spring element (110) carries the contact bridge (100).

19. The relay according to claim 18, characterized in that the elastic spring element (110) is connected to a twistable element (108) holding the contact bridge (100).

20. The relay according to claim 19, characterized in that the twistable element is a spring web (108).

21. The relay according to claim 19 or 20, characterized in that the twistable element (108) is formed onto the elastic spring element (110) as a unitary element.

22. The relay according to one of claims 19 to 21, characterized in that a contact bridge carrier (102) is formed onto the twistable element (108) as a unitary element.

23. The relay according to the preamble of claim 1, or according to one of the preceding claims, characterized in that the contact elements (60, 62) have connection elements (96, 98) protruding beyond the housing (10), and in that a connection element (96, 98) forms with a counter connection element (140) an electrical connection which can rotate about a longitudinal axis (80, 82) of the same.

24. The relay according to claim 23, characterized in that the connection elements (96, 98) are contact pins which are circular-cylindrical with respect to the longitudinal axis (80, 82).

25. The relay according to claim 23 or 24, characterized in that the counter connection elements (140) have ferrule terminals (146).

26. The relay according to claim 25, characterized in that the ferrule terminals (146) are provided with contact inserts (144).

27. The relay according to claim 26, characterized in that the contact inserts are formed as contact cages (144).

28. The relay according to claim 27, characterized in that the contact cage (144) has contact laminations (150).

29. The relay according to claim 28, characterized in that the contact laminations run in the axial direction and in the azimuthal direction around a center axis (152) of the contact cage (144).

30. The relay acording to one of claims 23 to 29, characterized in that the counter connection elements (140) are disposed in a connection housing (170).

31. The relay according to claim 30, characterized in that the counter connection elements (140) are rotatably disposed in the connection housing (170).

32. The relay according to the preamble of claim 1 or according to one of the preceding claims, characterized in that the contact elements (60, 62) form free-standing contact carrier bodies (64, 66) in the housing (10).

33. The relay according to claim 32, characterized in that the contact carrier bodies (64, 66) are provided on their end faces with contact parts (68, 70).

34. The relay according to the preamble of claim 1 or according to one of the peceding claims, characterized in that the contact elements (60, 62) are provided with plated-on contact parts (68, 70).

35. The relay according to claim 34, characterized in that the contact parts (68, 70) are produced from silver or palladium-silver.
